(19) United States
(12) Patent Application Publication
(10) Pub. No.: US 2019/0042941 A1
(43) Pub. Date: Feb. 7, 2019

(54) RECONFIGURABLE FABRIC OPERATION LINKAGE

(71) Applicant: Wave Computing, Inc., Campbell, CA (US)

(72) Inventors: Henrik Esbensen, Vista, CA (US); Peter Ramyalal Suaris, Woodland Hills, CA (US); Samit Chaudhuri, Cupertino, CA (US)

(21) Appl. No.: 16/054,225

(22) Filed: Aug. 3, 2018

Related U.S. Application Data
(60) Provisional application No. 62/541,697, filed on Aug. 5, 2017.
(60) Provisional application No. 62/547,769, filed on Aug. 19, 2017.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06N 3/08; G06Q 50/00; G06F 9/30

(52) U.S. Cl. CPC G06N 3/08; G06F 9/30181; G06Q 50/01

(57) ABSTRACT

Techniques are disclosed for reconfigurable fabric operation linkage. A first function to be performed on a reconfigurable fabric is determined, where the first function is performed on a first cluster within the reconfigurable fabric. A distance is calculated from the first cluster to a second cluster that receives output from the first function on the first cluster. A time duration is calculated for the output from the first function to travel to the second cluster. A first set of instructions for the first function is allocated to the first cluster based on the distance and the time duration. The allocating the first set of instructions is accomplished using a satisfiability solver technique including constructing a set of mapping constraints and building a satisfiability model. The satisfiability solver technique includes a Boolean satisfiability problem solving technique. The satisfiability model is solved and a solution is stored.

### RELATED APPLICATIONS

This application claims the benefit of U.S. provisional patent applications “Reconfigurable Fabric Operation Linkage” Ser. No. 62/541,697, filed Aug. 5, 2017, “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to instruction linkage and more particularly to reconfigurable fabric operation linkage.

### BACKGROUND

In recent years, the emerging ability to collect vast amounts of data has led to the desire to analyze that data. These immense datasets, frequently referred to as “big data”, cannot be analyzed using traditional techniques and processors simply because such analysis overwhelms the capabilities of the systems and techniques used to handle the data. In addition to data analysis, data capture, storage, maintenance, access, transmission, visualization, etc., quickly exceed the capabilities of the traditional systems. With no ability to address the needs and uses of the data, there would be little or no value to having the data at all. Instead, new processing techniques, algorithms, heuristics, and so on are required. Those who own the datasets or have access to the datasets, are eager to analyze the data contained therein. The analysis is performed for a variety of purposes including business analysis; disease detection, tracking, and control; crime detection and prevention; meteorology; complex science and engineering simulations, to name only a few. Advanced data analysis techniques such as predictive analytics are popular for extracting value from the datasets for business and other purposes. Other uses for the datasets include machine learning and deep learning.

Machine learning is based on the premise that computers can be trained to perform a given task without being specifically programmed for the given task. Such training builds algorithms to learn from a known dataset and uses that knowledge to make predictions about the current and future datasets. The advantage of machine learning is that the model-based algorithms can adapt and improve over time using past experience such as prediction success rates with data. A model is constructed from a set of sample data with known characteristics. The model is trained using the known data to make desired predictions and decisions. When trained, the model is then applied to other datasets. The model can be updated over time according to the success rate of the model to make correct predictions based on the data. Applications of such machine learned models include network and system intrusion detection; optical character recognition (OCR); email filtering for spam detection, computer vision (CV), and so on. The success of the model is limited by the quality of the training data. Analysis of the training data often requires human intervention, so such analysis is expensive and at risk of error.

Deep learning is often considered a subset of the larger class of machine learning techniques. Deep learning is a useful application of artificial neural networks. Deep learning is based on learning data representations rather than algorithms, which are task specific. Deep learning has been applied to a variety of research problems in areas such as speech recognition, computer vision, audio recognition, natural language processing, automatic (machine-based) translation, and social network filtering. Deep learning algorithms are based on layers of nonlinear processing elements that perform feature extraction, using unsupervised learning from levels of representations or features of data, and can learn different levels of abstraction based on levels of representations.

### SUMMARY

The processing of large volumes of unstructured data has found many applications in areas such as artificial intelligence, trend analysis, machine learning (including deep learning), and so on. Traditional approaches to data analysis have been based on designers building or buying faster processors, designing custom integrated circuits (chips), implementing application specific integrated circuits (ASIC), programming field programmable gate arrays (FPGA) etc. These approaches are based on computer and chip architectures that are focused on how control of the chip operations (control flow) is performed, rather than the flow of data through the chips. In a control flow architecture, the order of instructions, functions, and subroutines is determined a priori, and is therefore independent of the actual data being processed. To improve data processing capabilities, hardware acceleration can be used. Hardware acceleration can be achieved by parallelizing data analysis tasks, parallelizing processors, etc. While some increases in performance can be achieved, the parallelizing of the traditional hardware architectures alone does not scale well because of communication, control, and data flow limitations and bottlenecks. An alternative approach to the control flow architectures is to use a data flow architecture. In a data flow architecture, the execution of instructions, functions, subroutines, kernels, etc. is based on the presence or absence of data. This latter approach, that of a data flow architecture, is better suited to handling the large amounts of unstructured data that is processed as part of the machine learning and deep learning applications.

One such approach that supports a data flow architecture is based on a reconfigurable fabric. The reconfigurable fabric is based on processing elements (PE) and includes programming and communications capabilities. Each processing element has associated with it a circular buffer into which processing element instructions can be placed. The instructions in the circular buffer can be statically scheduled. The PE waits for valid data to be present. When valid data is present, the PE executes the code contained in the circular buffer that controls the processing element. The resulting data can be stored in distributed memory, stored outside the boundary of the reconfigurable fabric, etc. The resulting data can also be sent to another PE for further processing.

A data flow graph is a representation of the flow of data such as unstructured data and the processes to be performed on the data. The data flow graph describes data dependencies and what processes are performed on specific datasets, but does not describe timing. A data flow graph can be mapped to the reconfigurable fabric, where the various processes, functions, kernels, etc., which describe the nodes of the data flow graph, can be assigned to PEs and clusters of PEs within the reconfigurable fabric. The data flow graph dictates how data will flow among the various processes. In order for the data flow graph to be successfully carried out by the reconfigurable fabric, the operations performed by the reconfigurable fabric must be linked. The linking of the operations can be achieved by allocated sets of instructions that execute the functions, kernels, processes, etc. The allocations can be based on the time and path taken by data that flows from one PE or cluster of PEs to another PE or cluster of PEs.

Embodiments include a computer-implemented method for instruction linkage comprising: determining a first function to be performed on a reconfigurable fabric, wherein the first function is performed on a first cluster within the reconfigurable fabric; calculating a distance, within the reconfigurable fabric, from the first cluster to a second cluster that receives output from the first function on the first cluster; calculating a time duration for the output from the first function to travel to the second cluster through the reconfigurable fabric; and allocating a first set of instructions for the first function to the first cluster based on the distance and the time duration. The allocating the first set of instructions can be accomplished using a satisfiability solver technique comprising constructing a set of mapping constraints and building a satisfiability model of the mapping constraints. A second set of instructions for a second function to the second cluster based on the distance and the time duration can be allocated. The first set of instructions can be oriented with the second set of instructions. The orienting can provide synchronization of the output from the first function to input arrival needs of the second function. The orienting can include rotation of the first set of instructions within a circular buffer that controls the first cluster. The allocating the first set of instructions and the allocating the second set of instructions can accomplish linking of the first function and the second function. The linking can comprise symbolic linking.

Other embodiments include a computer program product embodied in a non-transitory computer readable medium for instruction linkage, the computer program product comprising code which causes one or more processors to perform operations of: determining a first function to be performed on a reconfigurable fabric, wherein the first function is performed on a first cluster within the reconfigurable fabric; calculating a distance, within the reconfigurable fabric, from the first cluster to a second cluster that receives output from the first function on the first cluster; calculating a time duration for the output from the first function to travel to the second cluster through the reconfigurable fabric; and allocating a first set of instructions for the first function to the first cluster based on the distance and the time duration. Still other embodiments include a computer system for instruction linkage comprising: a memory which stores instructions; one or more processors attached to the memory wherein the one or more processors, when executing the instructions which are stored, are configured to: determine a first function to be performed on a reconfigurable fabric, wherein the first function is performed on a first cluster within the reconfigurable fabric; calculate a distance, within the reconfigurable fabric, from the first cluster to a second cluster that receives output from the first function on the first cluster; calculate a time duration for the output from the first function to travel to the second cluster through the reconfigurable fabric; and allocate a first set of instructions for the first function to the first cluster based on the distance and the time duration.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for reconfigurable fabric operation.

FIG. 2 is a flow diagram for decomposing operations.

FIG. 3 is an example flow for a kernel mapper.

FIG. 4 shows a reconfigurable fabric cluster topology with topological and temporal distances.

FIG. 5A illustrates example processing of parallel processes and data.

FIG. 5B illustrates example processing of sequential processes and data.

FIG. 6 illustrates example circular buffer rotation for code alignment.

FIG. 7 shows a cluster for coarse-grained reconfigurable processing.

FIG. 8 illustrates a block diagram of a circular buffer.

FIG. 9 illustrates a circular buffer and processing elements.

FIG. 10 is an example flow graph.

FIG. 11 is a flow diagram for Boolean satisfiability problem solving.

FIG. 12 illustrates direct memory access (DMA) paths for transfers.

FIG. 13 shows scheduled sections.

FIG. 14 is a system diagram for reconfigurable fabric operation.

### DETAILED DESCRIPTION

Techniques are disclosed for linking operations within a reconfigurable computing environment. A data flow graph can represent functions, algorithms, heuristics, etc., that can process data. The data flow graph can be decomposed into smaller operations that can be allocated to single processing elements, clusters of processing elements, a plurality of clusters of processing elements, and so on. The data flow graph can be implemented within the reconfigurable computing environment. In a reconfigurable fabric, mesh network, or other suitable processing topology, the multiple processing elements (PE) obtain data, process the data, pass data to other processing elements, and so on. The processing that is performed can be based on sets of instructions that are allocated to a single PE, a cluster of PEs, a plurality of clusters of PEs, and etc. The clusters of PEs can be distributed across the reconfigurable fabric. In order for processing of the data to be performed effectively and efficiently, the data must arrive at a given PE within the reconfigurable fabric at the correct time and in the proper order. Similarly, the instructions executed by the PE must be in place at the PE and properly oriented such that the PE instructions are executed in the proper order. The correct data passing and PE instruction execution is accomplished by reconfigurable fabric operation linkage. Significant performance benefits can accrue to properly linked clusters within a reconfigurable fabric, including reducing latency, avoiding collisions, increasing throughput, and so on.

Reconfigurable fabric operation linkage is applied to instruction linkage. A first function to be performed on a reconfigurable fabric is determined, where the first function is performed on a first cluster within the reconfigurable fabric. A distance is calculated, within the reconfigurable fabric, from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique, such as a Boolean satisfiability solver technique, which comprises constructing a set of mapping constraints and building a satisfiability model of the mapping constraints. A second set of instructions is allocated for a second function to the second cluster based on the distance and the time duration. The first set of instructions is oriented with the second set of instructions. The allocating the first set of instructions and the allocating the second set of instructions accomplishes linking for the first function and the second function. In some embodiments, various operations listed above are accomplished in one step so that the first function and second function are determined to be performed on a first cluster and a second cluster respectively along with calculating distance and time duration across the reconfigurable fabric. Likewise the allocating of the instructions based on the distance and time duration can also be solved simultaneously with these other various operations.

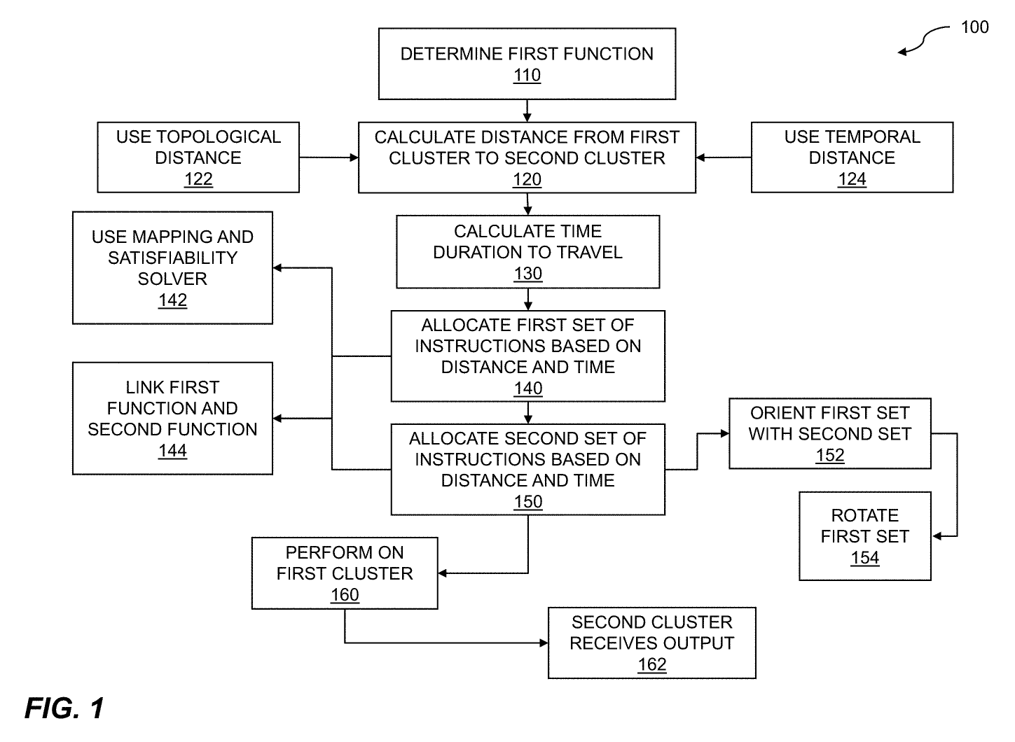

FIG. 1 is a flow diagram for reconfigurable fabric operation. The reconfigurable fabric operation can include reconfigurable fabric operation linkage. The flow 100 includes determining a first function 110 to be performed on a reconfigurable fabric, where the first function is performed on a first cluster within the reconfigurable fabric. A reconfigurable fabric can include a plurality of processing elements, circular buffers for controlling the processing elements, and communications links between and among the processing elements. The first function can include a kernel, where the kernel can include a component of a data flow graph that has been decomposed into a plurality of operations. The flow 100 includes calculating a distance, within the reconfigurable fabric, from the first cluster to a second cluster 120 that receives output from the first function on the first cluster. The first cluster and the second cluster may not be nearest neighbors, may not be in direct communication with one another, and so on. Instead, the two clusters can be separated by one or more intermediate processing elements within the reconfigurable fabric.

In embodiments, the distance calculation can use a topological distance 122 between clusters of the reconfigurable fabric. The topological distance can include a two-dimensional (2-D) distance, a three-dimensional (3-D) distance, and so on, based on the configuration of the reconfigurable fabric. For example, in a rectangular matrix of processing clusters, the topological distance can include the number of “hops” through the matrix in a Manhattan fashion required for a cluster output to get to its ultimate destination cluster. In other embodiments, the distance calculation can use a temporal distance 124. A temporal distance can include a time-based determination of the distance based on the total traversal interval required for a cluster output to get to its ultimate destination cluster.

The flow 100 includes calculating a time duration 130 for the output to travel from the first function to the second cluster through the reconfigurable fabric. When the output from the first function travels to the second cluster through the reconfigurable fabric, the data follows a path through the fabric. A plurality of paths can exist. Some possible paths may be shorter, involving transferring data through intermediate processing elements on the path between the first cluster and the second cluster. Other possible paths may be longer, taking one or more circuitous routes between the first cluster and the second cluster. The availability and capabilities of a given path can depend on operations being performed by the intermediate processing elements along a given path from the first cluster to the second cluster. Each path, whether direct, circuitous, etc., can determine a time duration for output to travel from the first cluster to the second cluster. In embodiments, the time duration can be a temporal distance between clusters of the reconfigurable fabric.

The flow 100 includes allocating a first set of instructions for the first function to the first cluster based on the distance and the time duration 140. The instructions can include processing element (PE) instructions and can execute a portion of or all of a first function. An instruction from the first set of instructions can correspond to a node in a data flow graph. The instructions can perform sequential operations, parallel operations, or a combination of both types of operations. In embodiments, the allocating the first set of instructions can be accomplished using a satisfiability solver technique comprising constructing a set of mapping constraints 142 and building a satisfiability model of the mapping constraints. Satisfiability solver techniques can include propositional techniques where logic expressions that are defined over variables can take values of either true or false. In embodiments, the satisfiability solver technique can include a Boolean satisfiability problem solving technique. The set of mapping constraints can describe the number of entities to which a given entity can be associated through a relationship set. For binary relationships, the mappings can include one to one, one to many, many to one, and many to many. The satisfiability model that can be built can be a model that can show a formula to be true. In embodiments, the satisfiability model can be solved. The satisfiability model can be a Boolean model. Solving the satisfiability model can include replacing variables in the satisfiability or Boolean model with the true or false values so that the satisfiability or Boolean model evaluates to true. In embodiments, the satisfiability model can include a satisfiability kernel mapper. A solution of the satisfiability model can be stored. The solution can be stored within the reconfigurable fabric, external to the reconfigurable fabric, online, in the cloud, and so on.

The allocating the first set of instructions 140 for the first function can facilitate passing of data. In embodiments, the allocating the first set of instructions can include being performed on a first cluster 160. The allocating the first set of instructions can facilitate passing data to a second cluster which receives the output 162 of the first cluster. In embodiments, the allocating the first set of instructions can facilitate passing data to a second cluster which is beyond a boundary of the reconfigurable fabric. The boundary of the reconfigurable fabric can be the boundary between a plurality of reconfigurable fabrics, a boundary between a reconfigurable fabric and a processor, and so on. Various techniques can be used for passing data beyond a boundary of the reconfigurable fabric. In embodiments, the passing data includes direct memory access (DMA) operations. The DMA operations can pass data across the boundary of the reconfigurable fabric without intervention by a processing element.

The flow 100 further includes allocating a second set of instructions 150 for a second function to a second cluster. The allocating the second set of instructions can be based on the distance 120 and the time duration 130. The first function and the second function can be part of a data flow graph implemented in the reconfigurable fabric. The first function and the second function can be sub-functions, kernels, load modules, etc. The second set of instructions can include processing element (PE) instructions and can execute a portion of or all of a second function. The instructions can perform sequential operations, parallel operations, or a combination of various types of operations. The first set of instructions and the second set of instructions can be stored in storage comprising a distributed memory. The distributed memory can be distributed across a reconfigurable fabric, can include memory beyond the boundary of the reconfigurable fabric, and so on. The allocating the first set of instructions and the allocating the second set of instructions can link a first operation and a second operation 144. Linking operations can include synchronizing output data requirements from the first operation to input data requirements for the second operation. Linking operations in a reconfigurable fabric are critical to meet timing and processing constraints of a data flow processor. Linking operations occurring between operations can run on two processing elements or two clusters of processing elements that are physically near each other or physically distant from each other within the reconfigurable fabric. Linking operations occurring among operations can run on three or more processing elements or three or more clusters of processing elements. Other combinations of processing elements and/or clusters of processing elements can be embodied. Operations involving other element types, such as switching elements or memory elements can also be embodied. The linking the first operation and the second operation can comprise orienting the first set of instructions with the second set of instructions 152. The orienting the first set with the second set can include rotating the first set 154.

The passing of data can include output from the first function that can be passed to the second cluster through the reconfigurable fabric. Since the duration of time required to pass the data from the first function to the second cluster is dependent on the path taken for the passing of the data, the second set of instructions allocated to the second cluster needs to be oriented such that the second set of instructions executes in the correct order when data arrives. The orienting can provide synchronization of the output of the first function to the input arrival needs of the second function. The orientating can take into account the different travel times of data sent along different paths. The orienting can include rotating instructions in a circular buffer, where the circular buffer controls a processing element in a cluster of processing elements to which a set of instructions can be assigned. In embodiments, the orienting includes rotation of the first set of instructions within a circular buffer that controls the first cluster. Orienting can include rotation of the second set of instructions within the circular buffer that controls the second cluster, and so on.

The functions that can be allocated to clusters of processing elements, within a reconfigurable fabric, can be obtained from decomposing an overall function into smaller operations. The overall function can be derived from a data flow graph, a function derived from a data flow graph, and so on. In order for the data flow graph to be executed properly, the various functions, smaller operations decomposed from the function, etc. can be linked together. In embodiments, the allocating the first set of instructions and the allocating the second set of instructions accomplishes linking for the first function and the second function. Various types of linking techniques can be used. The linking can include symbolic linking, hard linking, and so on.

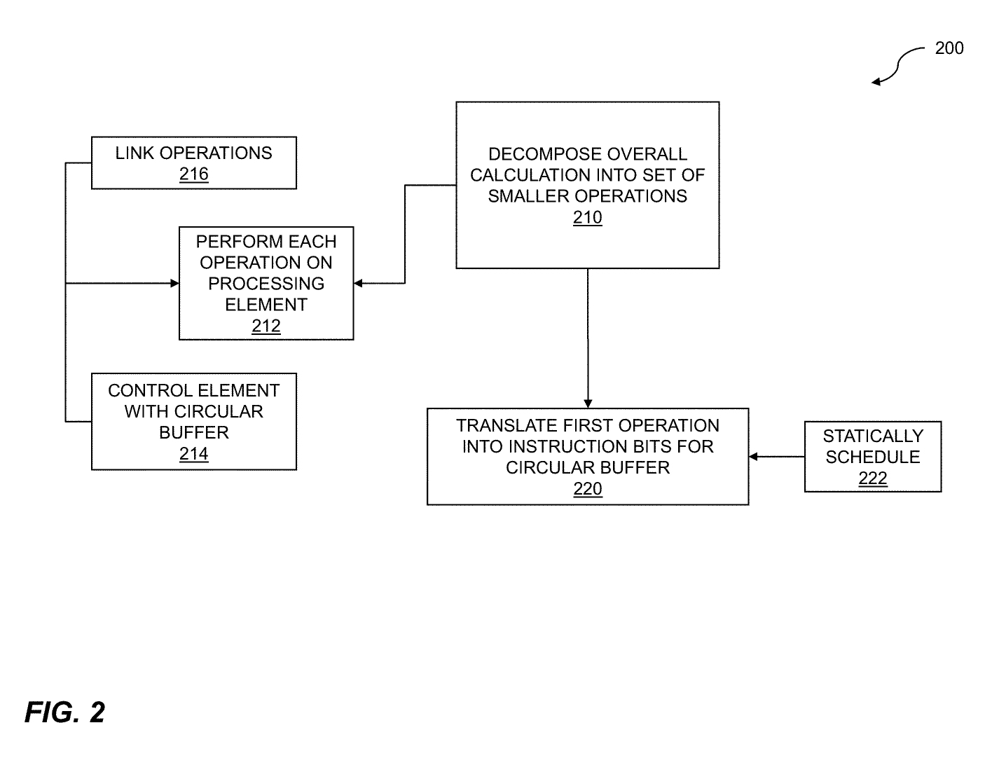

FIG. 2 is a flow diagram for decomposing operations. A data flow graph can be decomposed into a set of smaller operations, where the smaller operations can be performed on processing elements of a reconfigurable fabric. The operations can support reconfigurable fabric operation linkage. A first function to be performed on a reconfigurable fabric is determined, where the first function is performed on a first cluster within the reconfigurable fabric. A distance is calculated, within the reconfigurable fabric, from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a Boolean satisfiability solver technique comprising constructing a set of mapping constraints and building a satisfiability model of the mapping constraints. The model is solved and a solution stored.

The flow 200 includes decomposing an overall function into a set of smaller operations 210. The overall function can include a data flow graph, algorithm, heuristic, etc., which can be decomposed, partitioned, segmented, parallelized, and otherwise divided into smaller operations, functions, tasks, and so on. In embodiments, each of the smaller operations can be performed on a processing element 212 within the reconfigurable fabric and the processing element can be controlled by a circular buffer 214. The smaller operations can operate independently on data passed to the operations, can share data among operations, etc. The smaller operations can be linked 216. Linking allows synchronization of various operations performed on various processing elements across a reconfigurable fabric. In embodiments, the passing data can include direct memory access operations. The operations can be based on instructions which can be executed by the one or more processing elements (PE). In embodiments, the first set of instructions is loaded into the circular buffer. The flow 200 includes translating the first function into a set of instruction bits for a circular buffer 220 within the first cluster. The circular buffer can be statically scheduled, dynamically scheduled, and so on. As will be discussed shortly, the overall function that can be partitioned can be translated, compiled, “kernelized” (converted into executable kernels), or otherwise converted into instruction bits for the circular buffer. A circular buffer can be associated with a processing element. Each processing element can be associated with its own circular buffer. The circular buffer can be statically scheduled 222. Static scheduling is a process that allocates functions across the various elements of a reconfigurable fabric by executing a scheduling algorithm before the functions are executed along the reconfigurable fabric.

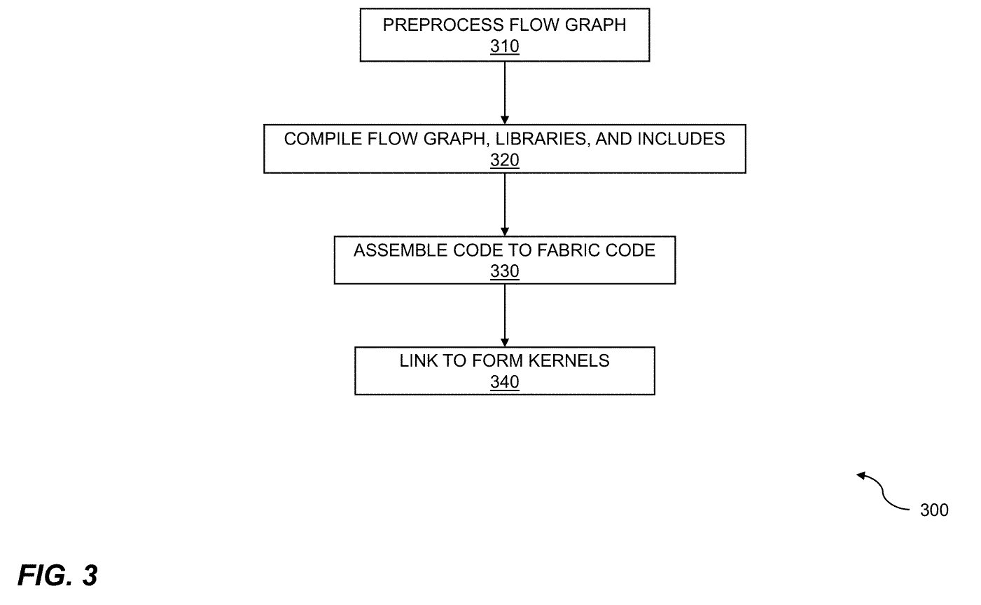

FIG. 3 is an example flow for a kernel mapper. A data flow graph can include kernels that can be mapped onto a reconfigurable fabric. The mapping can include reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

The mapping of a data flow graph to a reconfigurable fabric can include operations analogous to those of compiling code written in common coding languages such as C, C++, and so on. That is, the compiler operations such as preprocessing, compiling, assembling, and linking which form executable programs (load modules) have analogs in kernel mapping. The flow 300 includes preprocessing a flow graph 310. The preprocessing can include defining macros, naming libraries, identifying include files, and so on. The flow 300 includes compiling the flow graph with the libraries and “include” files 320. The steps of compilation can include converting the description of the data flow graph into an intermediate set of instructions. The analogous step in compilation would be to convert the high-level C code, C++ code, etc., into assembly instructions. The intermediate set of instructions, such as assembly instructions, can be instructions that are specific to processing elements (PE) of the reconfigurable fabric. The flow 300 includes assembling 330 intermediate code to fabric code. The fabric code, which can be analogous to machine code, can be code that can be executed by the processing elements in the reconfigurable fabric. For high-level languages such as C and C++, the machine code can be called object code. The flow 300 includes linking 340 the fabric code to form kernels. The kernels include all of the instructions necessary to form a module that is executable on the PEs. The linking arranges the machine instructions so that they can function properly together. The arranging of the machine instructions can support such operations as function calls, use of library routines, and so on.

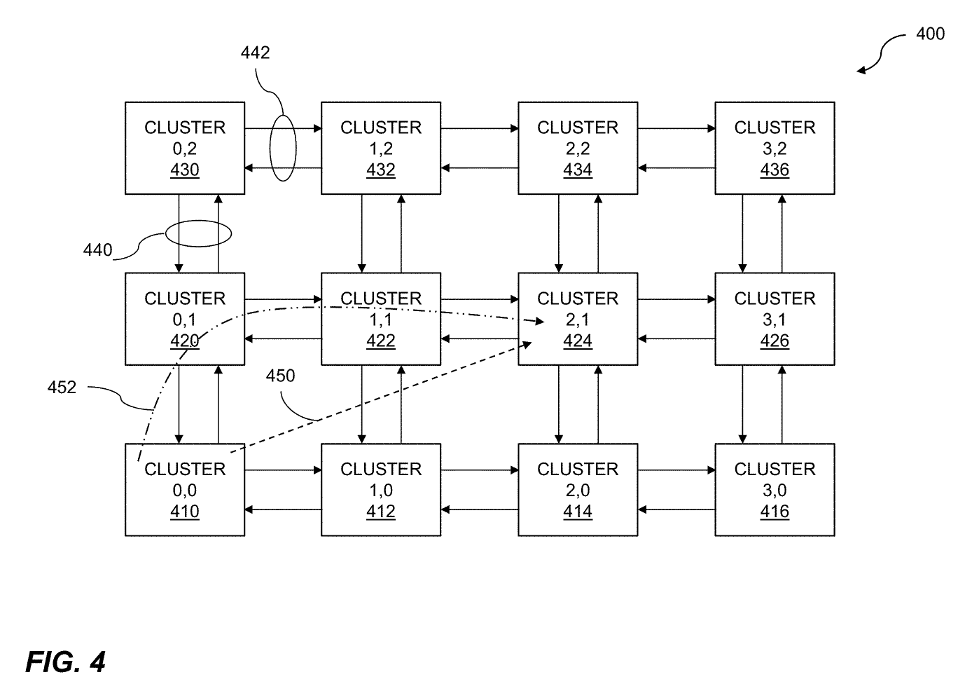

FIG. 4 shows a reconfigurable fabric cluster topology with topological and temporal distances. The fabric cluster topology can be part of a reconfigurable fabric and can support reconfigurable fabric operation linkage. A first function to be performed on a first cluster within a reconfigurable fabric is determined. A distance is calculated from the first cluster to a second cluster that receives output from the first function on the first cluster. A time duration is calculated for the output from the first function to travel to the second cluster through the reconfigurable fabric. A first set of instructions for the first function is allocated to the first cluster based on the distance and the time duration. The allocating the first set of instructions is accomplished using a satisfiability solver technique, which constructs a set of mapping constraints and builds a satisfiability model of the mapping constraints.

A cluster can include a cluster of processing elements (PE) comprising a reconfigurable fabric. The reconfigurable fabric can include a plurality of interconnected clusters. In the example figure, a cluster 430 has a cluster 432 to its east and a cluster 420 to its south. The cluster 430 exchanges data 440 with the southerly cluster 420 by using a south output connected to a north input of the cluster 420. Similarly, a south input of the cluster 430 is connected to a north output of the cluster 420. The cluster 430 exchanges data 442 with the cluster 432 oriented to the first cluster's east by using an east output connected to a west input of the second cluster 432. Similarly, an east input of cluster 430 is connected to a west output of cluster 432. In embodiments, the switching fabric is implemented with a parallel bus, such as a 32-bit bus. Other bus widths are possible, including, but not limited to, 16-bit, 64-bit, and 128-bit buses. Therefore, the configurable connections can provide for routing of a plurality of signals in parallel. In embodiments, the plurality of signals comprises four bytes. Communication through the configurable connections can be based on data being valid.

The fabric of clusters shown in FIG. 4 is a two-dimensional (2D) fabric, illustrating a mesh interconnection network where the clusters are placed in a two-dimensional grid. Each cluster is connected to its immediate neighbors as described in the case of the previously mentioned clusters as well as other clusters 410, 412, 414, 416, 422, 424, 426, 434, and 436. Hence, in embodiments, the switching fabric is used in mesh computing. Other embodiments have a fabric of more than two dimensions. The configurable connections can provide three-dimensional routing. A three-dimensional (3D) embodiment can have additional cluster interconnectivity. In one embodiment, the 3D fabric is formed by layering multiple 2D mesh interconnect fabrics. The three-dimensional routing can include accessing a stacked chip. The stacked chip can be a 3D-integrated circuit where multiple die are stacked and interconnected with through-silicon vias (TSV). In the case of three-dimensional routing, each cluster can have additional input and output ports. For example, in addition to the north, south, east, and west I/O ports, sets of up and down I/O ports can be present in each cluster to allow connectivity to clusters situated above and below a certain cluster. In embodiments, the configurable connections comprise a switching fabric that is attached to a plurality of processing elements. The configurable connections can route through one or more of silicon vias, two-dimensional connections, three-dimensional connections, or greater than three-dimensional connections.

For example, a setup such as a hypercube can allow for greater than three-dimensional interconnectivity. With n-dimensional hypercubes, the interconnection topology can comprise a plurality of clusters and a plurality of links, with n being an integer greater than or equal to three. Each cluster has a degree n, meaning that it is connected with links to n other clusters. The configurable connections can enable the bypassing of neighboring logical elements. In embodiments, some or all of the clusters in the fabric have a direct connection to a non-adjacent (non-neighboring) cluster. Within the fabric, each cluster of the plurality of clusters can have its own circular buffer. Therefore, the example diagram 400 includes a plurality of circular buffers. The plurality of circular buffers can have differing lengths. For example, the cluster 430 can have a circular buffer of length X, while the cluster 432 can have a circular buffer with a length of X+Y. In such a configuration, the cluster 430 sleeps after execution of the X−1 stage until the cluster 432 executes the X+Y−1 stage, at which point the plurality of circular buffers having differing lengths can resynchronize with the zeroth pipeline stage for each of the plurality of circular buffers. In an example where X=6 and Y=2, after the execution of a fifth stage, the cluster 430 sleeps until the cluster 432 executes the seventh stage, at which point both pipelines resynchronize and start executing the same stage together. The clusters (410-436) can be configured to function together to process data and produce a result. The result can be stored in one of the storage elements of a cluster. In some embodiments, the result is stored across multiple clusters. In embodiments, the switching fabric includes fan-in and fan-out connections. In embodiments, the storage elements store data while the configurable connections are busy with other data.

A distance can be calculated from a first cluster to a second cluster. The clusters can be clusters within the reconfigurable fabric. In embodiments, the distance can be a topological distance between clusters of the reconfigurable fabric. An example topological distance 450 is shown, where the topological distance can be the distance between cluster 0,0 410, and cluster 2,1 424. In this example, the cluster identification is using a standard Cartesian array with element cluster 0, 0 410 in the lower left corner and cluster 3,2 436 in the upper right-hand corner. The cluster identifications are shown for each of the clusters 410 through 436 in example 400. A time duration can be calculated for the output from the first function to travel to the second cluster through the reconfigurable fabric. In embodiments, the time duration can be a temporal distance between clusters of the reconfigurable fabric. An example temporal distance 452 is shown. The temporal distance can include routing data from a first cluster 0,0 410, through intervening clusters, to second cluster 2,1 424. While the temporal distance 452 shown is based on routing data from cluster 0,0 410 through cluster 0,1 420 and cluster 1,1 422 to cluster 2,1 424, other paths which include other time periods can be taken. Another temporal distance can include routing data from cluster 0,0 410 through cluster 1,0 412 and cluster 1,1 422 to cluster 2,1 424. Other routes and corresponding time periods, including less efficient routes and longer time periods, can be taken based on paths that may be available a given time.

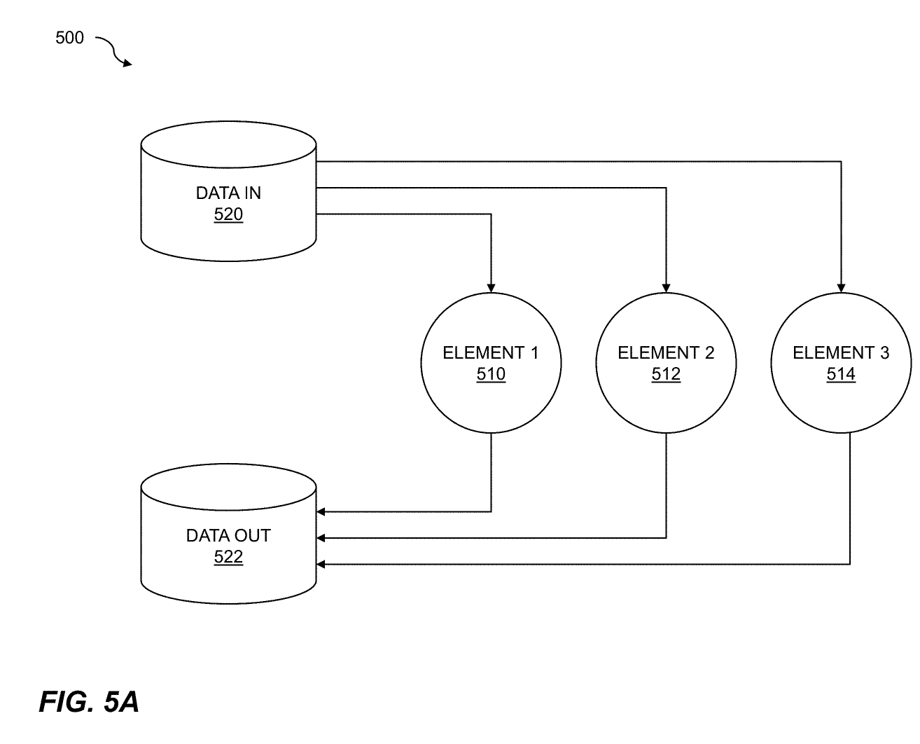

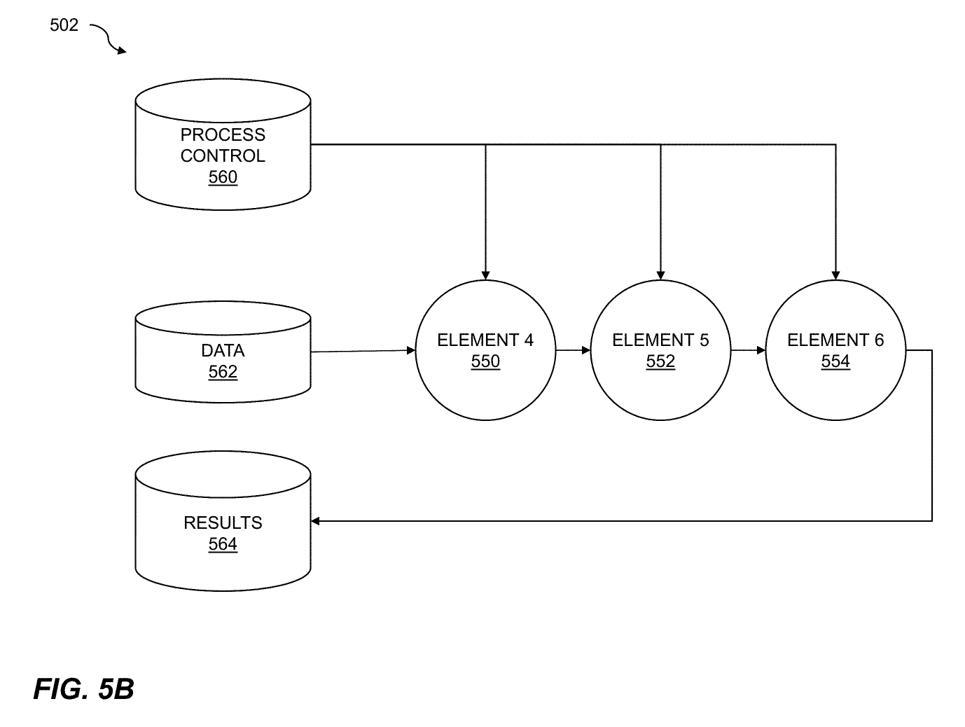

FIG. 5A illustrates example processing of parallel processes and data. Processes that can be accomplished on a reconfigurable fabric can include tasks that can be processed in parallel. The parallel processes can operate on data in parallel. The processing of the parallel processes and data 500 can support reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

Processes that can be executed in parallel can include independent processes, similar processes, multiple instances of the same processes, and so on. The processes can operate on data that can be independent data, blocks of data from sources such as image data, audio data, financial data, etc. The processes can be processed in parallel for various purposes such as increasing processing throughput, and so on. Blocks of input data can be provided from data in 520 and can be directed to one or more processing elements such as element 1 510, element 2 512, element 3 514, and so on. The processing elements can be processing elements of the reconfigurable fabric. The processes can generate output data. The output data can be accumulated, stored, archived, etc. in data out 522. Data in 520 and/or data out 522 can be outside the reconfigurable fabric.

FIG. 5B illustrates example processing of sequential processes and data. Processes and data can be processed sequentially 502. Sequential processing of the processes and the data can support reconfigurable fabric operation linkage. A first function to be performed on a reconfigurable fabric is determined, where the first function is performed on a first cluster within the reconfigurable fabric. A distance is calculated from the first cluster to a second cluster, and a time duration is calculated for the output from the first function to travel to the second cluster. A first set of instructions for the first function is allocated to the first cluster based on the distance and the time duration. The allocating the first set of instructions is accomplished using a satisfiability solver technique. A set of mapping constraints is constructed and a satisfiability model is built. The model is solved and a solution is stored.

Processes and data can be processed sequentially 502. Sequential processing can accomplish a variety of tasks such as serial encryption, convolution, and so on. The serial encryption or other functions can be stored in process control 560. Portions of or all of the contents of process control 560 can be distributed to processing elements. The processing elements can include one or more processing elements of the reconfigurable fabric such as element 4 550, element 5 552, element 6 554, and so on. Data 562 can be routed through the reconfigurable fabric and passed to element 4 550. The data 562 can be stored in the reconfigurable fabric, provided from a source external to the reconfigurable fabric, and so on. The passing data can include direct memory access (DMA) operations. As element 4 550 processes data 562, element 4 can provide data such as intermediate results to element 5 552. As element 5 552 processes data, element 5 can provide data to element 6 554. As element 6 554 processes data, element 6 can provide data to results 564. The results 564 can be stored in the reconfigurable fabric, provided to a source external to the reconfigurable fabric, and so on.

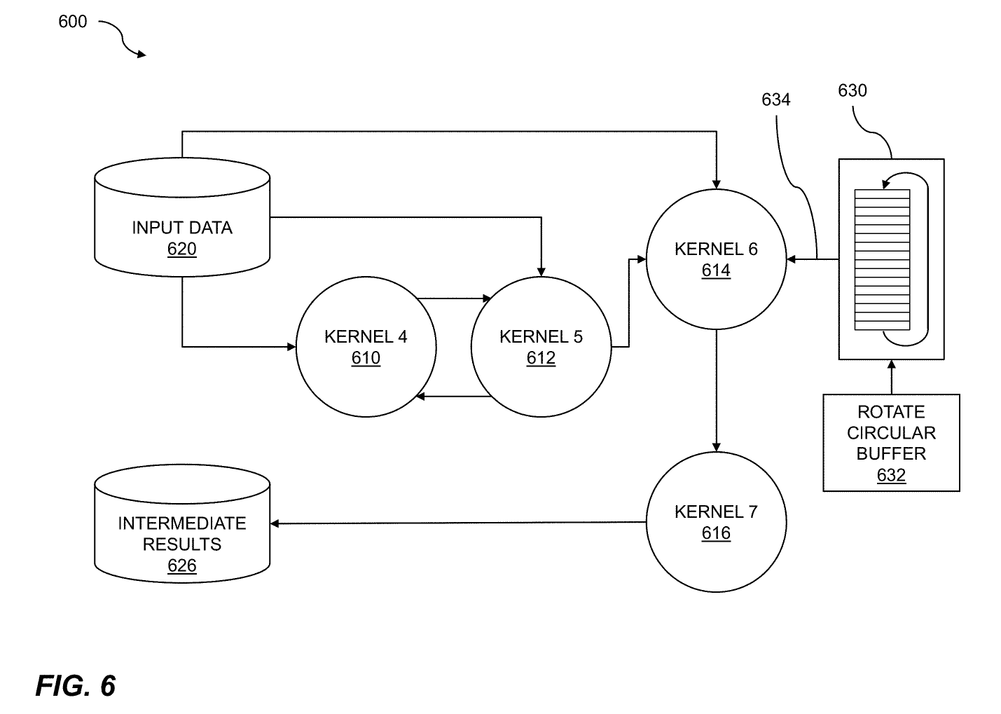

FIG. 6 illustrates example circular buffer rotation for code alignment. Circular buffer rotation for code alignment can be used to synchronize output of a first function to the input arrival needs of a second function. The circular buffer rotation can support reconfigurable fabric operation linkage. A first function to be performed on a first cluster within a reconfigurable fabric is determined. A distance is calculated from the first cluster to a second cluster that receives output from the first function on the first cluster. A time duration is calculated for the output from the first function to travel to the second cluster through the reconfigurable fabric. A first set of instructions for the first function is allocated to the first cluster based on the distance and the time duration. The allocating the first set of instructions is accomplished using a satisfiability solver technique, which constructs a set of mapping constraints and builds a satisfiability model of the mapping constraints.

Example circular buffer rotation for code alignment is shown 600. Input data 620 can be routed to kernels such as kernel 4 610, kernel 5 612, kernel 6 614, and so on. A kernel can be a block of code, a function, a routine, a subroutine, an algorithm, etc. A kernel can correspond to a flow graph module that has been compiled. A kernel can cover one or more clusters in a fabric. Data flow dependencies can exist between and among the kernels, such as data flowing back and forth between kernel 4 610 and kernel 5 612, and data flowing from kernel 5 612 to kernel 6 614. In order for kernel 6 614 to process data from the input data 620 and data from kernel 5 612, kernel 6 614 “waits” for the data from kernel 5 612 to be ready. While kernel 6 614 waits for data from kernel 5 612, the circular buffer 630 that contains instructions to control 634 kernel 6 614 can continue to rotate. In order for kernel 6 to execute correctly, the first instruction for the kernel must be the first instruction to be executed. The rotation of the circular buffer 630 can be controlled by a signal, flag, etc., that can rotate the circular buffer 632. Recall that circular buffers control processing elements of the fabric, and by extension, the circular buffers execute each of the kernels. The rotating of the circular buffer 630 can include orienting a first set of instructions that controls a first kernel with a second set of instructions that controls a second kernel. The first kernel can be a function. In embodiments, the orienting can provide synchronization of the output of the first function to the input arrival needs of the second function. Kernel 7 616 can wait for output to be provided from kernel 6 614. When output from kernel 6 614 is provided to kernel 7 616, then kernel 7 616 can process the data from kernel 6 614 and can provide intermediate results 626, output data, processed data, and so on.

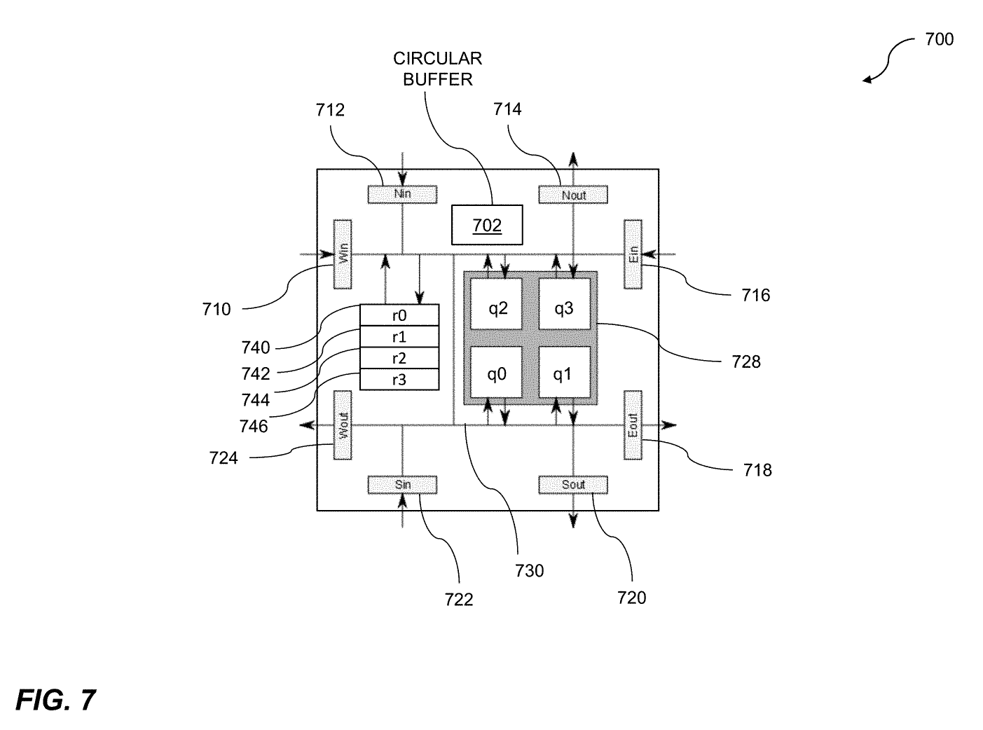

FIG. 7 shows a cluster for coarse-grained reconfigurable processing. Course-grained reconfigurable processing 700 can be used for reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 700 comprises a circular buffer 702. The circular buffer 702 can be referred to as a main circular buffer or a switch-instruction circular buffer. In some embodiments, the cluster 700 comprises additional circular buffers corresponding to processing elements within the cluster. The additional circular buffers can be referred to as processor instruction circular buffers. The example cluster 700 comprises a plurality of logical elements, configurable connections between the logical elements, and a circular buffer 702 controlling the configurable connections. The logical elements can further comprise one or more of switching elements, processing elements, or storage elements. The example cluster 700 also comprises four processing elements: q0, q1, q2, and q3. The four processing elements can collectively be referred to as a “quad,” and can be jointly indicated by a grey reference box 728. In embodiments, there is intercommunication among and between each of the four processing elements. In embodiments, the circular buffer 702 controls the passing of data to the quad of processing elements 728 through switching elements. In embodiments, the four processing elements 728 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 700 can further comprise storage elements coupled to the configurable connections. As shown, the cluster 700 comprises four storage elements-r0 740, r1 742, r2 744, and r3 746. The cluster 700 further comprises a north input (Nin) 712, a north output (Nout) 714, an east input (Ein) 716, an east output (Eout) 718, a south input (Sin) 722, a south output (Sout) 720, a west input (Win) 710, and a west output (Wout) 724. The circular buffer 702 can contain switch instructions that implement configurable connections. For example, an instruction effectively connects the west input 710 with the north output 714 and the east output 718 and this routing is accomplished via bus 730. The cluster 700 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 702. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 724 to an instruction placing data on the south output 720, such that the data can be output on both output ports within the same pipeline cycle. In a case where data needs to travel to a cluster that is both south and west of the cluster 700, it can be more efficient to send the data directly to the south output port rather than storing the data in a register first, and then sending the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighbor L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to them to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

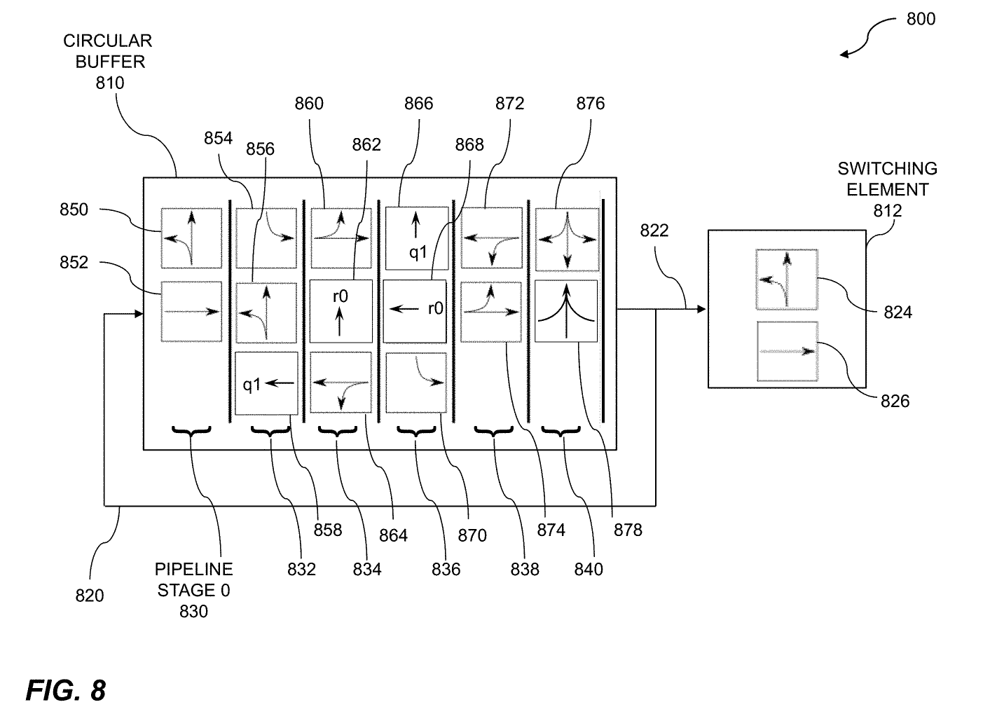

FIG. 8 illustrates a block diagram of a circular buffer. A circular buffer can be used for controlling reconfigurable fabric operation linkage. A first function to be performed on a first cluster within a reconfigurable fabric is determined. A distance is calculated from the first cluster to a second cluster that receives output from the first function on the first cluster. A time duration is calculated for the output from the first function to travel to the second cluster through the reconfigurable fabric. A first set of instructions for the first function is allocated to the first cluster based on the distance and the time duration. The allocating the first set of instructions is accomplished using a satisfiability solver technique, which constructs a set of mapping constraints and builds a satisfiability model of the mapping constraints.

The FIG. 800 illustrates a block diagram of a circular buffer 810 and a corresponding switching element 812. The circular buffer and the corresponding switching element can be used in part for remote usage of machine learned layers by a second machine learning construct. A first data group is collected in a first locality and is applied to a first localized machine learning construct. A first set of convolutional layers is determined within the first localized machine learning construct based on the first data group where the first set of convolutional layers includes a first data flow graph machine. The first set of convolutional layers is sent to a second localized machine learning construct. A second data group is analyzed by the second machine learning construct using the first set of convolutional layers.

Returning to the FIG. 800, for the circular buffer 810 and the corresponding switching element 812, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 800 describes a processor-implemented method for data manipulation. The circular buffer 810 contains a plurality of pipeline stages. Each pipeline stage contains one or more instructions, up to a maximum instruction depth. In the embodiment shown in FIG. 8, the circular buffer 810 is a 6×3 circular buffer, meaning that it implements a six-stage pipeline with an instruction depth of up to three instructions per stage (column). Hence, the circular buffer 810 can include one, two, or three switch instruction entries per column. In some embodiments, the plurality of switch instructions per cycle can comprise two or three switch instructions per cycle. However, in certain embodiments, the circular buffer 810 supports only a single switch instruction in a given cycle. In the example 800 shown, Pipeline Stage 0 830 has an instruction depth of two instructions 850 and 852. Though the remaining pipeline stages 1-5 are not textually labeled in the FIG. 800, the stages are indicated by callouts 832, 834, 836, 838, and 840. Pipeline stage 1 832 has an instruction depth of three instructions 854, 856, and 858. Pipeline stage 2 834 has an instruction depth of three instructions 860, 862, and 864. Pipeline stage 3 836 also has an instruction depth of three instructions 866, 868, and 870. Pipeline stage 4 838 has an instruction depth of two instructions 872 and 874. Pipeline stage 5 840 has an instruction depth of two instructions 876 and 878. In embodiments, the circular buffer 810 includes 64 columns. During operation, the circular buffer 810 rotates through configuration instructions. The circular buffer 810 can dynamically change operation of the logical elements based on the rotation of the circular buffer. The circular buffer 810 can comprise a plurality of switch instructions per cycle for the configurable connections.

The instruction 852 is an example of a switch instruction. In embodiments, each cluster has four inputs and four outputs, each designated within the cluster's nomenclature as “north,” “east,” “south,” and “west” respectively. For example, the instruction 852 in the diagram 800 is a west-to-east transfer instruction. The instruction 852 directs the cluster to take data on its west input and send out the data on its east output. In another example of data routing, the instruction 850 is a fan-out instruction. The instruction 850 instructs the cluster to take data from its south input and send out on the data through both its north output and its west output. The arrows within each instruction box indicate the source and destination of the data. The instruction 878 is an example of a fan-in instruction. The instruction 878 takes data from the west, south, and east inputs and sends out the data on the north output. Therefore, the configurable connections can be considered to be time multiplexed.

In embodiments, the clusters implement multiple storage elements in the form of registers. In the example 800 shown, the instruction 862 is a local storage instruction. The instruction 862 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 858 is a processing instruction. The instruction 858 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 800 shown, the circular buffer 810 rotates instructions in each pipeline stage into switching element 812 via a forward data path 822, and also back to a pipeline stage 0 830 via a feedback data path 820. Instructions can include switching instructions, storage instructions, and processing instructions, among others. The feedback data path 820 can allow instructions within the switching element 812 to be transferred back to the circular buffer. Hence, the instructions 824 and 826 in the switching element 812 can also be transferred back to pipeline stage 0 as the instructions 850 and 852. In addition to the instructions depicted on FIG. 8, a no-op instruction can also be inserted into a pipeline stage. In embodiments, a no-op instruction causes execution to not be performed for a given cycle. In effect, the introduction of a no-op instruction can cause a column within the circular buffer 810 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by stimulus external to the logical element and not based on the programming of the logical element. The external stimulus can include an input signal, which in turn can cause a wake up or an interrupt service request to execute on one or more of the logical elements. An example of such a wake-up request can be seen in the instruction 858, assuming that the processor q1 was previously in a sleep state. In embodiments, when the instruction 858 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 866. In the case of the instruction 866, data from the processor q1 is moved to the north output. In some embodiments, if Xs have been placed into the processor q1, such as during the instruction 858, then Xs would be retrieved from the processor q1 during the execution of the instruction 866 and applied to the north output of the instruction 866.

A collision occurs if multiple instructions route data to a particular port in a given pipeline stage. For example, if instructions 852 and 854 are in the same pipeline stage, they will both send data to the east output at the same time, thus causing a collision since neither instruction is part of a time-multiplexed fan-in instruction (such as the instruction 878). To avoid potential collisions, certain embodiments use preprocessing, such as by a compiler, to arrange the instructions in such a way that there are no collisions when the instructions are loaded into the circular buffer. Thus, the circular buffer 810 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 862), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0, thereby preventing a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

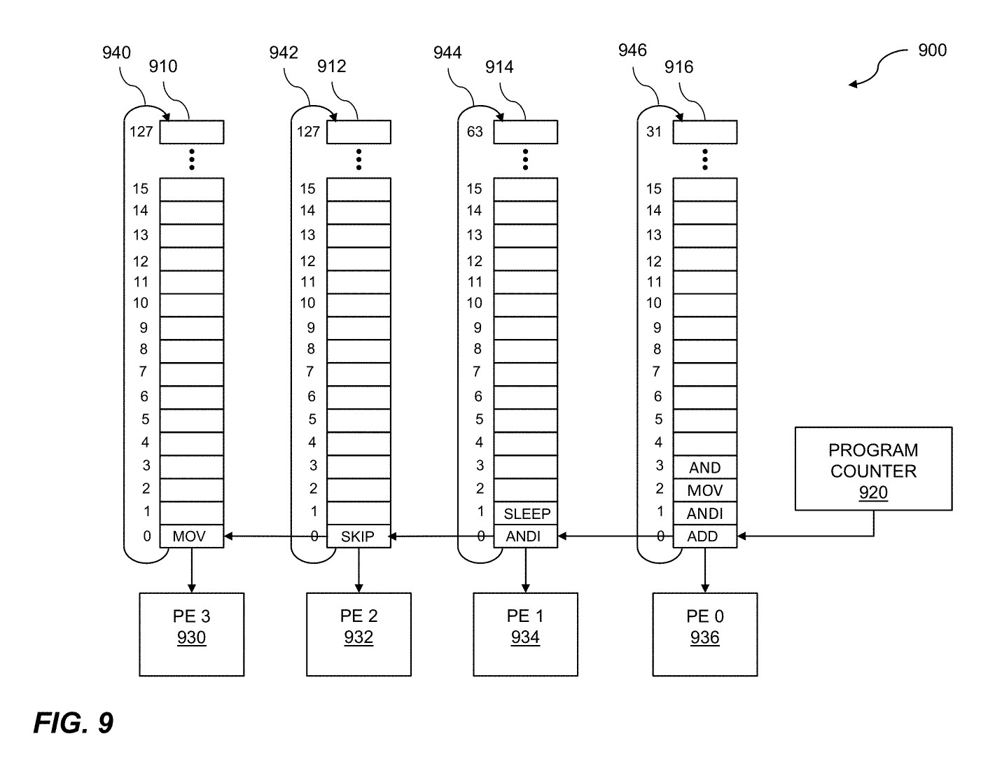

FIG. 9 illustrates a circular buffer and processing elements. This figure shows a diagram 900 indicating example instruction execution for processing elements. The instruction execution can include reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

A circular buffer 910 feeds a processing element (PE) 930. A second circular buffer 912 feeds another processing element 932. A third circular buffer 914 feeds another processing element 934. A fourth circular buffer 916 feeds another processing element 936. The four processing elements 930, 932, 934, and 936 can represent a quad of processing elements. In embodiments, the processing elements 930, 932, 934, and 936 are controlled by instructions received from the circular buffers 910, 912, 914, and 916. The circular buffers can be implemented using feedback paths 940, 942, 944, and 946, respectively. In embodiments, the circular buffer can control the passing of data to a quad of processing elements through switching elements, where each of the quad of processing elements is controlled by four other circular buffers (as shown in the circular buffers 910, 912, 914, and 916) and where data is passed back through the switching elements from the quad of processing elements where the switching elements are again controlled by the main circular buffer. In embodiments, a program counter 920 is configured to point to the current instruction within a circular buffer. In embodiments with a configured program counter, the contents of the circular buffer are not shifted or copied to new locations on each instruction cycle. Rather, the program counter 920 is incremented in each cycle to point to a new location in the circular buffer. The circular buffers 910, 912, 914, and 916 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction, causing the instruction in the circular buffer to be ignored and ultimately the corresponding operation will not be performed.

The plurality of circular buffers can have differing lengths. That is, the plurality of circular buffers can comprise circular buffers of differing sizes. In embodiments, the circular buffers 910 and 912 have a length of 128 instructions, the circular buffer 914 has a length of 64 instructions, and the circular buffer 916 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 9, different circular buffers can have different instruction sets within them. For example, circular buffer 910 contains a MOV instruction. Circular buffer 912 contains a SKIP instruction. Circular buffer 914 contains a SLEEP instruction and an ANDI instruction. Circular buffer 916 contains an AND instruction, a MOVE instruction, an ANDI instruction, and an ADD instruction. The operations performed by the processing elements 930, 932, 934, and 936 are dynamic and can change over time, based on the instructions loaded into the respective circular buffers. As the circular buffers rotate, new instructions can be executed by the respective processing element.

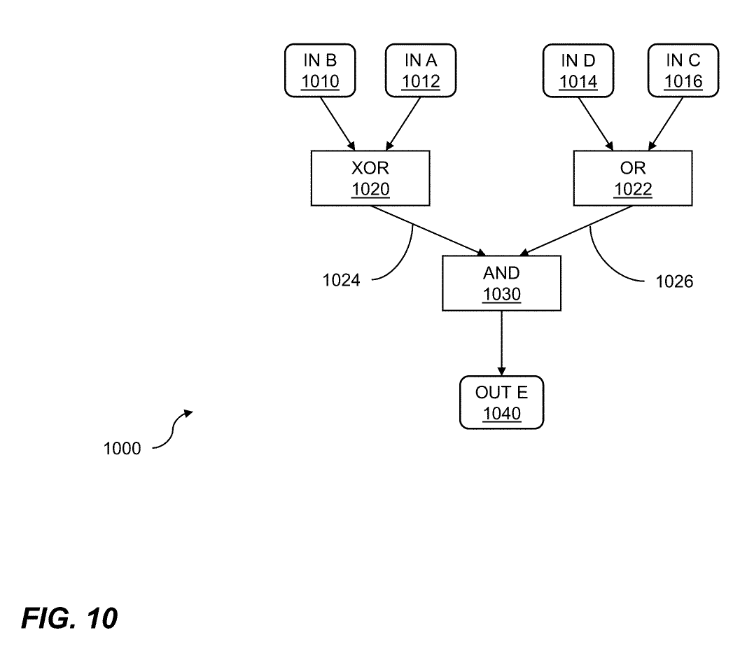

FIG. 10 is an example flow graph. The graph 1000 is a flow graph for reconfigurable fabric operation linkage. A first function to be performed on a first cluster within a reconfigurable fabric is determined. A distance is calculated from the first cluster to a second cluster that receives output from the first function on the first cluster. A time duration is calculated for the output from the first function to travel to the second cluster through the reconfigurable fabric. A first set of instructions for the first function is allocated to the first cluster based on the distance and the time duration. The allocating the first set of instructions is accomplished using a satisfiability solver technique, which constructs a set of mapping constraints and builds a satisfiability model of the mapping constraints.

The example flow 1000 can include one or more entry, or initial, nodes such as node B 1010, node A 1012, node D 1014, and node C 1016, for example. Any number of entry (initial) nodes can be included. The entry nodes 1010, 1012, 1014, and 1016 can handle input data, where the input data can include binary data, alphanumeric data, graphical data, and so on. For example, binary input data can include a bit, a nibble, a byte, a binary vector, and so on. The entry nodes can be connected by one or more arcs (vertices) to one or more other nodes. For example, the entry nodes B 1010 and A 1012 can be connected to an intermediate node 1020, and the entry nodes D 1014 and C 1016 can be connected to another intermediate node 1022. The nodes can serve any purpose appropriate to reconfigurable fabric operation linkage, including Boolean operations, mathematical operations, storage operations, and so on. For example, the intermediate node 1020 can perform an XOR Boolean operation, and the intermediate node 1022 can perform an OR Boolean operation. More complex Boolean operations or other operations can also be performed.

The intermediate nodes 1020 and 1022 of the example flow graph 1000 can be connected to one or more other nodes, where the other nodes can be intermediate nodes, exit (terminal) nodes, and so on. Returning to the example, the intermediate nodes 1020 and 1022 can be connected by the arcs (vertices) 1024 and 1026, respectively, to another intermediate node 1030. As before, the intermediate node or nodes can serve any purpose appropriate to logic circuitry. For example, the intermediate node 1030 can perform an AND Boolean operation. Other complex operations, Boolean operations, and so on, can also be performed. The intermediate node 1030 can be connected to one or more other nodes, where the other nodes can be intermediate nodes, exit or terminal nodes, and so on. Continuing with the example, the intermediate node 1030 can be connected to an exit or terminal node OUT E 1040. The node OUT E 1040 can serve as an input to another flow, as a storage node or a communication node, and so on. While one flow graph is shown, many flow graphs could be similarly executed, executed simultaneously, and so on.

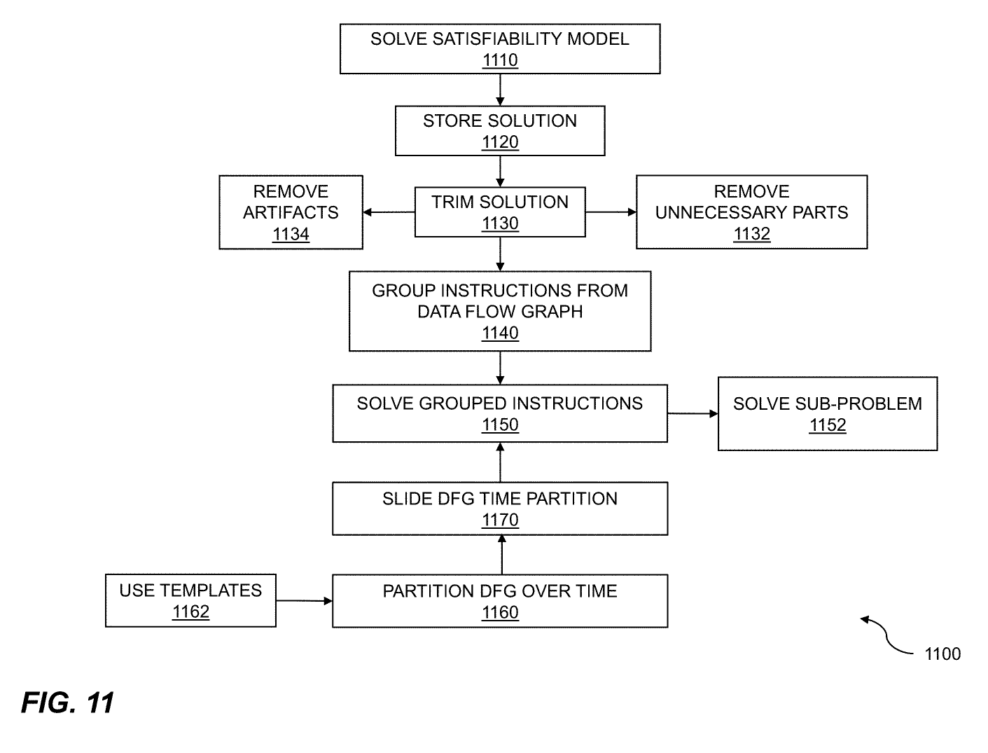

FIG. 11 is a flow diagram for Boolean satisfiability problem solving. The Boolean satisfiability problem solving can be performed to accomplish reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

The Boolean Satisfiability Problem (or SAT) is the problem of determining if a proposition statement is satisfiable. A propositional statement is satisfiable when it is possible to assign some true-false values for the variables in the statement such that the statement yields a Boolean True. Otherwise the statement is unsatisfiable. By using Boolean equations that represent the mapping constraints and resources of a reconfigurable fabric, a satisfiability solver can be used to identify a configuration for a reconfigurable fabric.

The flow 1100 includes solving the satisfiability model 1110. In embodiments, the satisfiability solver is search based and uses a variety of intelligent techniques to explore new regions of the search space while looking for a satisfying assignment. In some embodiments, the satisfiability solver utilizes a Davis-Putnam-Logemann-Loveland (DPLL) process.

The flow 1100 includes storing a solution of the satisfiability model 1120. The stored satisfiability model may be stored in a non-volatile storage such as an optical hard disk, solid state hard disk, flash memory, or other suitable storage medium. The storing of the model can include, but is not limited to, storing topology information, initial settings of registers, initial instructions and values stored in circular buffers, placement of intermediate FIFOs, and/or other configuration information for the reconfigurable fabric.

The flow 1100 includes trimming the solution 1130, wherein the trimming includes removing unnecessary parts 1132 from the solution. The unnecessary parts can include branches that did not resolve to a satisfiable solution. The satisfiability solver may utilize a backtracking algorithm to enhance performance over a brute-force approach. The satisfiability solver may order the search to maximize the amount of search space that can be trimmed.

In embodiments, the trimming further comprises removing artifacts 1134. Furthermore, in embodiments, the removing artifacts employs a satisfiability model restricted to a current known solution. Artifacts are unnecessary usages of registers and instructions. They can appear as a consequence of the incremental mapping flow or generally when there is no objective that tries to minimize register usage or instructions. In embodiments, the satisfiability solver technique further comprises grouping instructions from the data flow graph 1140. The satisfiability solver technique includes solving the instructions which were grouped 1150. In embodiments, the solving the instructions which were grouped 1150 comprises solving a sub-problem 1152. The solving can include identifying a solution to a Boolean equation that is representative of a portion of the physical and temporal dimensions of a reconfigurable fabric. The portion can be a sub-problem.

The flow 1100 includes grouping or partitioning the data flow graph (DFG) over time 1160. This is necessary because it may be impossible to solve a complex DFG over the entire constraint time. A slice or partition of time can contain a much more manageable set of constraints to solve. The partition can be made over a time-related region or section of the DFG in which constraints can be solved in a time local fashion. The flow 1100 includes using templates 1162 to solve the constraints of the DFG. A template describes a method to generate specific content in specific resources at specific sub-tics out of other content. Templates can also be used to model only instructions, primary inputs, and/or primary outputs. The flow 1100 includes sliding the DFG time partition 1170 on a time basis earlier and later in the DFG flow. Local satisfiability is thereby optimized as the time partition is moved backwards and forwards. Solutions can be modified to avoid sub-optimizations within only a single time partition. The time slice can comprise a clock cycle of the reconfigurable fabric.

In further embodiments, the solving the instructions is across a set of sub-tics within the reconfigurable fabric. In embodiments, a time step can be referred to as a tic or a sub-tic. In essence, a time step is a period of time over which logic signals are maintained or are settled to specific values. In embodiments, the processing elements within the reconfigurable fabric are synchronized within a time step. In embodiments, partitioning the data flow graph into time partitions is performed along with solving the satisfiability model for a time partition. In embodiments, the time partitions comprise regions of the data flow graph. In embodiments, moving the time partition forward and backward in time optimizes the solving the satisfiability model across the backward in time partition, the time partition, and the forward in time partition. In embodiments, a template is applied, wherein the template describes local constraints for a node in the time partition of the data flow graph.

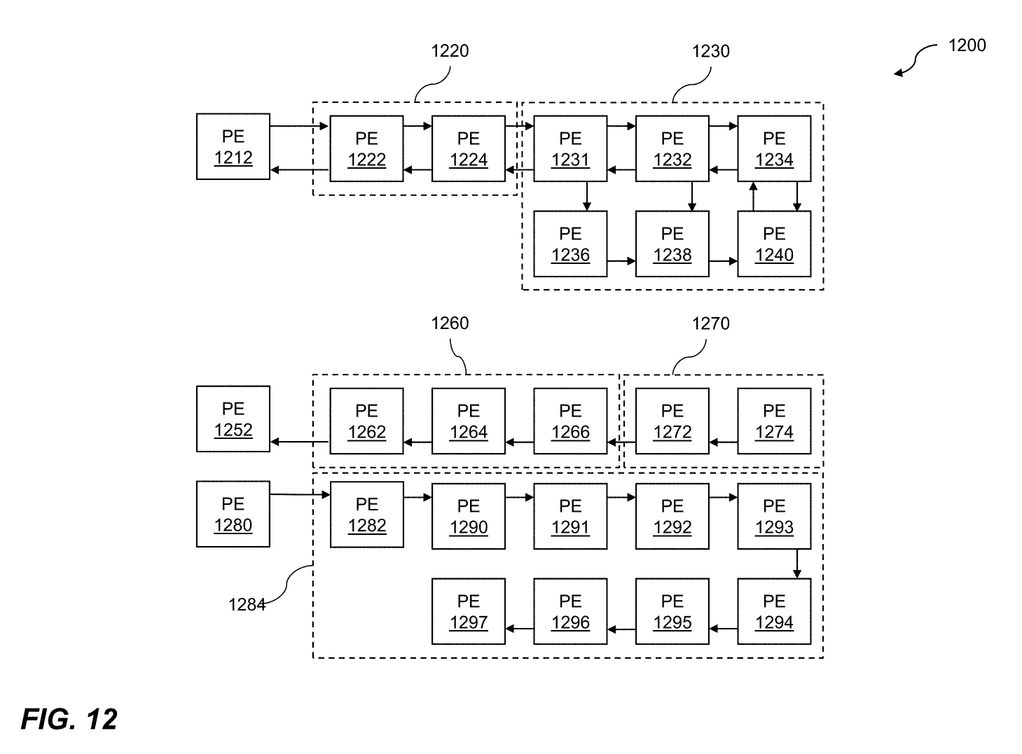

FIG. 12 illustrates direct memory access (DMA) paths for transfers. DMA paths for transfers can include reconfigurable fabric operation linkage. A first function to be performed on a first cluster within a reconfigurable fabric is determined. A distance is calculated from the first cluster to a second cluster that receives output from the first function on the first cluster. A time duration is calculated for the output from the first function to travel to the second cluster through the reconfigurable fabric. A first set of instructions for the first function is allocated to the first cluster based on the distance and the time duration. The allocating the first set of instructions is accomplished using a satisfiability solver technique, which constructs a set of mapping constraints and builds a satisfiability model of the mapping constraints.

In the example shown in 1200, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). Processing elements and switching elements that are designated as masters can establish DMA paths for transfers 1200 to slaves. A master 1212 can establish a DMA path 1220 that includes processing elements 1222 and 1224 to slave processing elements 1230. The slave processing elements can include 1231, 1232, 1234, 1236, 1238, and 1240. The slave processing elements and switching elements can include readers and writers.

There are three basic DMA modes of operation (listed in order of priority and complexity of implementation): DMA initiated by an advance microcontroller bus such as an advance extensible interface (AXI™) bus to a quad, and quad to the interface bus; processor initiated, interface bus to a quad, and quad to the interface bus; and processor-initiated quad to quad.

For interface bus-initiated DMA transfers, some processing elements can be operated as slaves, responding to a DMA protocol implemented on top of the data transfers across switching elements. These transfers can occur without any involvement of the processing elements. DMA transfers occur over a DMA path that is established by the router between the microcontroller interface (AXI™), and the set of clusters that are involved in the transfer. This path is a sequence of scheduled switch instructions that provides a path for data to move between the addressed cluster (e.g. 1230) and the AXI™ interface. The flow control for both read and write transfers to a cluster is managed by the AXI™ interface. There is no mechanism for asserting back pressure to the fabric, so the AXI™ interface must supply a data token that flows through the fabric for all pieces of read and write data. If the AXI™ wants to fetch another word, it sends an empty DMA data token down the DMA path through the fabric. An empty DMA data token has the various status bits all set to ‘0’—to indicate empty data. The cluster that is responding to the DMA will fill the token with the next piece of data and it will flow back out to the AXI™ interface. For write-only transfers, the path travels from the AXI™ interface to the destination clusters without a return path. For read-only and read/write transfers, the path travels from the AXI™ interface to the addressed clusters, and back again to the AXI™ interface. The AXI™ interface can use this type of path for both read and write transfers. The AXI4™ protocol does not support read+write transfers. To increase the data bandwidth, the router should establish more paths in parallel through the fabric, down which more data can be streamed. The router should ensure that the paths provide the data tokens at the destination clusters in the same order as they are sourced from the AXI™ bus.

Processing elements can initiate DMA transfers to and from the microcontroller bus. Each block contains two AXI™ master interfaces (AMI or AXIM). Each interface is connected to four FIFO-to-fabric blocks and can support 64 independently managed FIFO channels. A cluster 1270 can initiate an AXI™ transfer by sending a request to one of the AMI™ blocks via an uplink data channel. The cluster can include processing elements 1272 and 1274. The uplink channel 1260 can include multiple processing elements and/or switching elements 1262, 1264, 1266, etc. The uplink channel 1260 can feed PE 1252. The AMI™ block will send a response back to the processing element cluster via the matching downlink channel. Both channels should be configured as streaming data, and the flow control in the uplink channel should be managed using the credit counter in the requesting cluster. The request includes a system address and an address for the transfer. For a read operation, the data is transferred from the system address and a DMA transfer is established that writes the data to the address (in the destination cluster). For a write operation, a DMA transfer is set up to read the data from the address in the source cluster and send it out to the system address.

Processing elements can initiate cluster to cluster transfers. This class of DMA transfer requires a cluster to become a master in a transfer that is entirely within the switching element/processing element fabric. It can therefore happen at very high transfer rate, depending on the available DMA paths established between the clusters.

A processing element 1280 can initiate a DMA transfer between itself and other clusters 1284 in the array, or between other clusters. A DMA path 1282 is established by the router between all of the clusters participating in the transfer 1284. The path starts and finishes with the cluster that will be the master for the transfers. The master transmits DMA header tokens down the path such as 1282 to 1290, 1291, 1292, 1293, 1294, 1295, 1296, and 1297, to all the clusters that will participate in the transfer. This is achieved by setting the parameters in the control registers and executing the DMA read/write instructions on the master. These headers address the possible readers and writers in the path (including the master cluster itself) and set up the parameters for the transfer. A reader is a cluster that reads data from its Quad data RAM and feeds it into the data path. A DMA transfer can have a single reader and multiple writers and typically all will execute the transfer in a DMA slave state. In some instances, the master is reading from its own memory, in which case, the DMA read is executing in the DMA master state. DMA fan-out enables data to be transferred from one cluster to many others in a single DMA operation. When the headers are all sent out, the processing executes a DMA start instruction which initiates a state machine that identifies the opportunities for it to master data transfers. Data tokens are sent into the DMA path using a switch instruction. The tokens must flow through the readers before flowing to the writers. As the tokens pass through the readers, the addressed cluster will fill the token with data. Each of the writers will copy the data token and write the data into its Quad RAM.

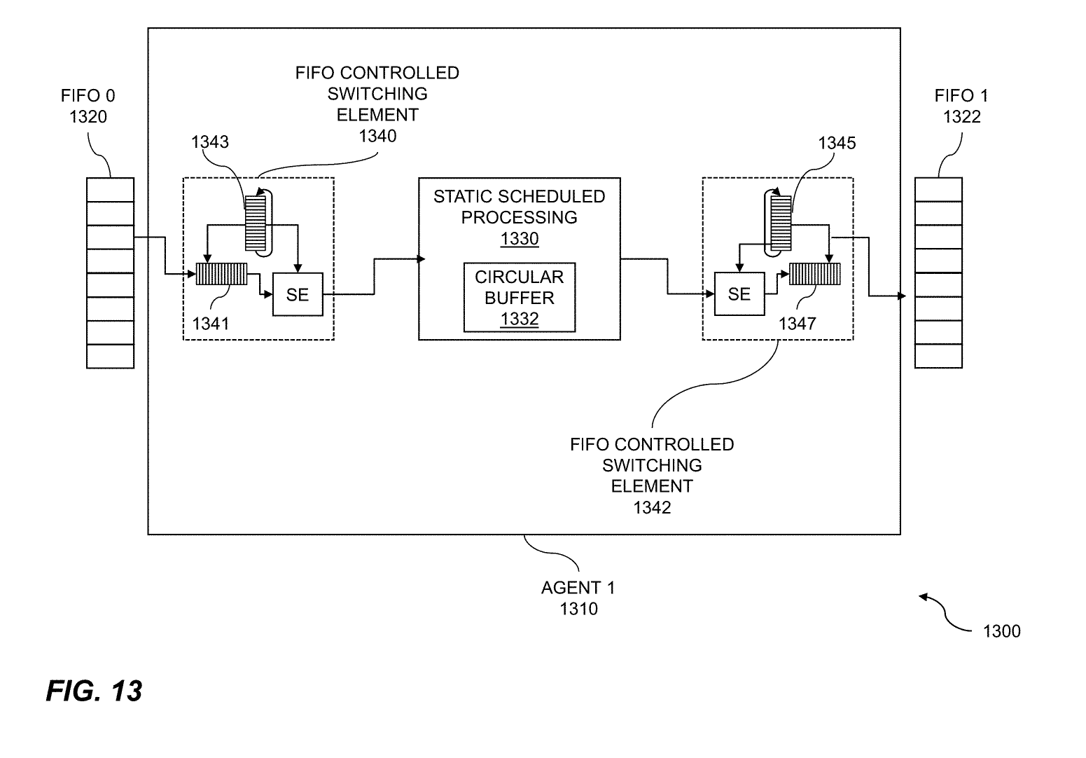

FIG. 13 shows scheduled sections. In example 1300 shown, the scheduled selections can include reconfigurable fabric operation linkage. A first function to be performed on a reconfigurable fabric is determined. The first function is performed on a first cluster within the reconfigurable fabric. A distance is calculated from the first cluster to a second cluster that receives output from the first function on the first cluster. A time duration is calculated for the output from the first function to travel to the second cluster through the reconfigurable fabric. A first set of instructions is allocated for the first function to the first cluster based on the distance and the time duration. The allocating the first set of instructions is accomplished using a satisfiability solver technique such as a Boolean satisfiability solver. A set of mapping constraints is constructed and a satisfiability model is built. The model is solved and a solution is stored.

In the example 1300, FIFO 1320 serves as an input FIFO for a control agent 1310. Data from FIFO 1320 is read into local buffer 1341 of FIFO controlled switching element 1340. Circular buffer 1343 may contain instructions that are executed by a switching element (SE), and may modify data based on one or more logical operations, including, but not limited to, XOR, OR, AND, NAND, and/or NOR. The plurality of processing elements can be controlled by circular buffers. The modified data may be passed to a circular buffer 1332 under static scheduled processing 1330. Thus, the scheduling of circular buffer 1332 may be performed at compile time. The instructions loaded into circular buffer 1332 may occur as part of a program initialization, and may remain in the circular buffer 1332 throughout the execution of the program (control agent). The circular buffer 1332 may provide data to FIFO controlled switching element 1342. Circular buffer 1345 may rotate to provide a plurality of instructions/operations to modify and/or transfer data to data buffer 1347, and is then transferred to external FIFO 1322.

A process agent can include multiple components. An input component handles retrieval of data from an input FIFO. For example, agent 1310 receives input from FIFO 0 1320. An output component handles the sending of data to an output FIFO. For example, agent 1310 provides data to FIFO 1 1322. A signaling component can signal to process agents executing on neighboring processing elements about conditions of a FIFO. For example, a process agent can issue a FIRE signal to another process agent operating on another processing element when new data is available in a FIFO that was previously empty. Similarly, a process agent can issue a DONE signal to another process agent operating on another processing element when new space is available in a FIFO that was previously full. In this way, the process agent facilitates communication of data and FIFO states amongst neighboring processing elements to enable complex computations with multiple processing elements in an interconnected topology.

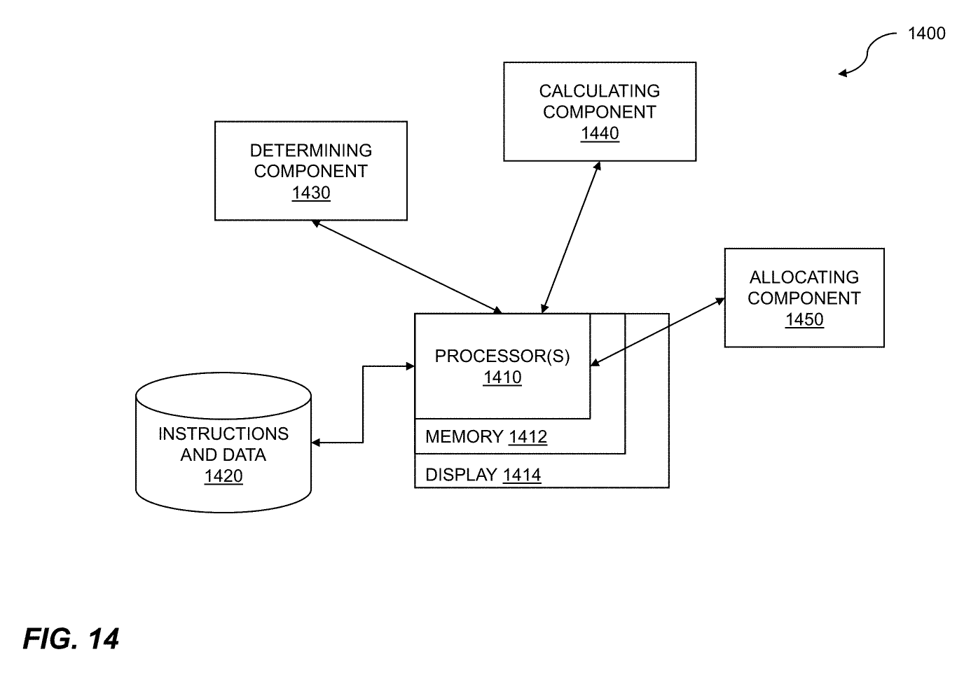

FIG. 14 is a system diagram for reconfigurable fabric operation. The system 1400 can include one or more processors 1410 coupled to a memory 1412 which stores instructions. The system 1400 can include a display 1414 coupled to the one or more processors 1410 for displaying data, intermediate steps, instructions, and so on. In embodiments, one or more processors 1410 are attached to the memory 1412 where the one or more processors, when executing the instructions which are stored, are configured to: determine a first function to be performed on a reconfigurable fabric, wherein the first function is performed on a first cluster within the reconfigurable fabric; calculate a distance, within the reconfigurable fabric, from the first cluster to a second cluster that receives output from the first function on the first cluster; calculate a time duration for the output from the first function to travel to the second cluster through the reconfigurable fabric; and allocate a first set of instructions for the first function to the first cluster based on the distance and the time duration.

The system 1400 can include a collection of instructions and data 1420. The instructions and data 1420 may be stored in a database, one or more statically linked libraries, one or more dynamically linked libraries, precompiled headers, source code, flow graphs, or other suitable formats. The instructions can include instructions for operation linkage from one or more upstream processing elements in a reconfigurable fabric. The instructions can include satisfiability solver techniques. The instructions can include mapping constraints and satisfiability models.

The system 1400 can include a determining component 1430. The determining component 1430 can include functions and instructions for determining functions, sub-functions, etc., to be performed on the reconfigurable fabric. The system 1400 can include a calculating component 1440. The calculating component 1440 can include functions and instructions for calculating a distance from the first cluster to a second cluster, where the clusters are located within the reconfigurable fabric. The calculating component 1440 can include functions and instructions for calculating a time duration for the output from the first function to travel to the second cluster through the reconfigurable fabric. The system 1400 can include an allocating component 1450. The allocating component 1450 can allocate a first set of instructions for the first function to the first cluster based on the distance and the time duration.

The system 1400 can include a computer program product embodied in a non-transitory computer readable medium for instruction linkage, the computer program product comprising code which causes one or more processors to perform operations of: determining a first function to be performed on a reconfigurable fabric, wherein the first function is performed on a first cluster within the reconfigurable fabric; calculating a distance, within the reconfigurable fabric, from the first cluster to a second cluster that receives output from the first function on the first cluster; calculating a time duration for the output from the first function to travel to the second cluster through the reconfigurable fabric; and allocating a first set of instructions for the first function to the first cluster based on the distance and the time duration.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. Various operations and analyses can be performed using Tensorflow™, Keras™, MXNet™, Caffe™, GEMM™, Sigmoid™, Softmax™, CNTK™, and the like. Deep learning, convolutional neural nets (CNN), recurrent neural nets (RNN), and the like can be implemented using technology described in this paper. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for instruction linkage comprising:
determining a first function to be performed on a reconfigurable fabric, wherein the first function is performed on a first cluster within the reconfigurable fabric;
calculating a distance, within the reconfigurable fabric, from the first cluster to a second cluster that receives output from the first function on the first cluster;
calculating a time duration for the output from the first function to travel to the second cluster through the reconfigurable fabric; and
allocating a first set of instructions for the first function to the first cluster based on the distance and the time duration.

2. The method of claim 1 wherein the allocating the first set of instructions is accomplished using a satisfiability solver technique comprising constructing a set of mapping constraints and building a satisfiability model of the mapping constraints.

3. The method of claim 1 further comprising allocating a second set of instructions for a second function to the second cluster based on the distance and the time duration.

4. The method of claim 3 further comprising orienting the first set of instructions with the second set of instructions.

5. The method of claim 4 wherein the orienting provides synchronization of the output from the first function to input arrival needs of the second function.

6. The method of claim 5 wherein the orienting includes rotation of the first set of instructions within a circular buffer that controls the first cluster.

7. The method of claim 3 wherein the allocating the first set of instructions and the allocating the second set of instructions is accomplished using a satisfiability solver technique.

8. The method of claim 7 wherein the satisfiability solver technique comprises a Boolean satisfiability problem solving technique.

9. The method of claim 8 further comprising solving a satisfiability model.

10. (canceled)

11. The method of claim 9 wherein the satisfiability model includes a satisfiability kernel mapper.

12. The method of claim 3 wherein the allocating the first set of instructions and the allocating the second set of instructions accomplishes linking of the first function and the second function.

13. The method of claim 12 wherein the linking comprises symbolic linking.

14. (canceled)

15. The method of claim 3 wherein the first function and the second function are part of a data flow graph implemented in the reconfigurable fabric.

16. The method of claim 3 wherein an instruction from the first set of instructions corresponds to a node in a data flow graph.

17. The method of claim 1 further comprising decomposing an overall function into a set of smaller operations.

18. The method of claim 17 wherein each of the smaller operations is performed on a processing element within the reconfigurable fabric and the processing element is controlled by a circular buffer.

19. The method of claim 18 wherein the first set of instructions is loaded into the circular buffer.

20. The method of claim 1 wherein the allocating the first set of instructions includes instructions facilitating passing data beyond a boundary of the reconfigurable fabric.

21. The method of claim 20 wherein the passing data includes direct memory access operations.

22. The method of claim 1 further comprising translating the first function into a set of instruction bits for a circular buffer within the first cluster.

23. The method of claim 22 wherein the circular buffer is statically scheduled.

24. The method of claim 1 wherein the distance is a topological distance between clusters of the reconfigurable fabric.

25. The method of claim 1 wherein the time duration is a temporal distance between clusters of the reconfigurable fabric.

26. The method of claim 1 wherein the reconfigurable fabric is configured to perform machine learning.

27. The method of claim 26 wherein the machine learning that is performed implements a data flow graph.

28. A computer program product embodied in a non-transitory computer readable medium for instruction linkage, the computer program product comprising code which causes one or more processors to perform operations of:
determining a first function to be performed on a reconfigurable fabric, wherein the first function is performed on a first cluster within the reconfigurable fabric;
calculating a distance, within the reconfigurable fabric, from the first cluster to a second cluster that receives output from the first function on the first cluster;
calculating a time duration for the output from the first function to travel to the second cluster through the reconfigurable fabric; and
allocating a first set of instructions for the first function to the first cluster based on the distance and the time duration.

29. A computer system for instruction linkage comprising:
a memory which stores instructions;
one or more processors attached to the memory wherein the one or more processors, when executing the instructions which are stored, are configured to:
determine a first function to be performed on a reconfigurable fabric, wherein the first function is performed on a first cluster within the reconfigurable fabric;
calculate a distance, within the reconfigurable fabric, from the first cluster to a second cluster that receives output from the first function on the first cluster;
calculate a time duration for the output from the first function to travel to the second cluster through the reconfigurable fabric; and
allocate a first set of instructions for the first function to the first cluster based on the distance and the time duration.
